(19) United States
(12) Patent Application Publication
(10) Pub. No.: US 2024/0322124 A1
(43) Pub. Date: Sep. 26, 2024

(54) POSITIVE ELECTRODE AND FLUORIDE-ION SECONDARY BATTERY

(71) Applicant: HONDA MOTOR CO., LTD., Tokyo (JP)

(72) Inventor: Kazuyuki SATO, Saitama (JP)

(21) Appl. No.: 18/585,085

(22) Filed: Feb. 23, 2024

(30) Foreign Application Priority Data
Mar. 24, 2023 (JP) 2023-048317

(51) Int. Cl. H01M 4/36; H01M 4/02; H01M 4/134; H01M 4/136; H01M 4/38; H01M 4/58; H01M 10/0562

(52) U.S. Cl. CPC H01M 4/364; H01M 4/134; H01M 4/136; H01M 4/38; H01M 4/582; H01M 10/0562; H01M 2004/028; H01M 2300/0068

(57) ABSTRACT

Provided is a positive electrode including: a positive electrode current collector; and a positive electrode material mixture layer provided on the positive electrode current collector, in which the positive electrode material mixture layer includes a first active material containing no fluorine; and a second active material containing no fluorine and has a molar ratio of the first active material relative to the second active material of 4 or more and 35 or less, and the first active material has a fluorination potential higher than that of the second active material.

This application is based on and claims the benefit of priority from Japanese Patent Application No. 2023-048317, filed on 24 Mar. 2023, the content of which is incorporated herein by reference.

### BACKGROUND OF THE INVENTION

### Field of the Invention

The present invention relates to a positive electrode and a fluoride-ion secondary battery.

### Related Art

In recent years, fluoride-ion secondary batteries that contribute to energy efficiency have been researched and developed to ensure that more people have access to affordable, reliable, sustainable, and advanced energy.

Patent document 1 discloses a fluoride-ion battery having a positive electrode active material layer including a Cu-based active material and BiF₃. The positive electrode active material layer is formed by a process including: forming a precursor layer including a Cu-based active material and Bi, and then introducing fluoride ions into the precursor layer.
Patent Document 1: Japanese Unexamined Patent Application, Publication No. 2022-178410

### SUMMARY OF THE INVENTION

Unfortunately, the fluoride-ion battery disclosed in Patent Document 1 will have an insufficient discharge capacity per unit mass of the positive electrode active material layer.

It is an object of the present invention to provide a positive electrode that has a positive electrode material mixture layer and can form a fluoride-ion secondary battery with an increased discharge capacity per unit mass of the positive electrode material mixture layer.

According to a first aspect of the present invention, a positive electrode includes: a positive electrode current collector; and a positive electrode material mixture layer provided on the positive electrode current collector, the positive electrode material mixture layer including: a first active material containing no fluorine; and a second active material containing no fluorine, the positive electrode material mixture layer having a molar ratio of the first active material relative to the second active material of 4 or more and 35 or less, the first active material having a fluorination potential higher than that of the second active material.

According to a second aspect of the present invention, in the positive electrode as described in the first aspect, the first active material and the second active material form a composite.

According to a third aspect of the present invention, in the positive electrode as described in the first or second aspect, the positive electrode material mixture layer further includes a third active material containing fluorine, and the third active material has a fluoride-ion conductivity higher than that of a fluoride of the second active material.

According to a fourth aspect of the present invention, in the positive electrode as described in the third aspect, the first active material is copper, the second active material is bismuth, and the third active material is a compound that is represented by the formula:

$${K}_{x} B {i}_{1 - x} {F}_{3 - 2 x} ,$$

wherein x is 0.02 or more and 0.12 or less,
and has a hexagonal structure.

According to a fifth aspect of the present invention, in the positive electrode as described in the third or fourth aspect, the first active material is in the form of particles with a primary particle size of 10 nm or more and 500 nm or less, the second active material is in the form of particles with a primary particle size of 10 nm or more and 500 nm or less, and the third active material is in the form of particles with a primary particle size of 10 nm or more and 200 nm or less.

According to a sixth aspect of the present invention, in the positive electrode as described in any one of the first to fifth aspects, the positive electrode material mixture layer further includes a solid electrolyte containing fluorine.

According to a seventh aspect of the present invention, in the positive electrode as described in the sixth aspect, the solid electrolyte is a metal fluoride containing cerium and strontium.

According to an eighth aspect of the present invention, a fluoride-ion secondary battery includes the positive electrode as described in any one of the first to seventh aspects.

The present invention provides a positive electrode that has a positive electrode material mixture layer and can form a fluoride-ion secondary battery with an increased discharge capacity per unit mass of the positive electrode material mixture layer.

### BRIEF DESCRIPTION OF THE DRAWINGS

FIG. 1 is a graph showing the fluoride-ion conductivities of K_{0.06}Bi_{0.94}F_{2.88} and BiF₃;

FIG. 2 is a photograph showing a transmission electron microscope (TEM) image and elemental mapping of K_{0.06}Bi_{0.94}F_{2.88};

FIG. 3 is a photograph showing a scanning electron microscope (SEM) image of K_{0.06}Bi_{0.94}F_{2.88};

FIG. 4 is a photograph showing an SEM image and elemental mapping of a positive electrode material mixture of Example 1;

FIG. 5 is an X-ray diffraction (XRD) spectrum of a positive electrode material mixture of Example 1; and

FIG. 6 is a graph showing the charge-discharge curve of a cell of Example 3.

### DETAILED DESCRIPTION OF THE INVENTION

Hereinafter, embodiments of the present invention will be described.

### Positive Electrode

An embodiment of the present invention is directed to a positive electrode including: a positive electrode current collector; and a positive electrode material mixture layer provided on the positive electrode current collector, in which the positive electrode material mixture layer includes a first active material containing no fluorine; and a second active material containing no fluorine. In the positive electrode, the first active material has a fluorination potential higher than that of the second active material.

The molar ratio of the first active material to the second active material is 4 or more and 35 or less, and is preferably 4 or more and 20 or less. The positive electrode material mixture layer with a molar ratio of the first active material to the second active material of 4 or more and 35 or less can form a fluoride-ion secondary battery with an increased discharge capacity per unit mass of the positive electrode material mixture layer. For example, the first and second active materials may be Cu and Bi, respectively. In this case, if the molar ratio of Cu to Bi is less than 4, the positive electrode material mixture layer may form a fluoride-ion secondary battery with a lower energy density per unit mass of the positive electrode material mixture layer, and if the molar ratio of Cu to Bi is more than 35, the positive electrode material mixture layer may form a fluoride-ion secondary battery that will have a lower efficiency of supply of ions to Cu due to the formation of BiF₃ during charging.

The first active material may be any suitable metal having a fluorination potential higher than that of the second active material, such as Cu, Co (III), or Mo. The first active material may include a combination of two or more of such metals. In particular, the first active material is preferably Cu in view of the discharge capacity of the fluoride-ion secondary battery per unit mass of the positive electrode material mixture layer.

The fluorination potential of the first active material is typically, but not limited to, 0.3 V or more (vs. Pb/PbF₂) and 1.5 V or less (vs. Pb/PbF₂).

The first active material is preferably in the form of particles with a primary particle size of 10 nm or more and 500 nm or less, and is more preferably 10 nm or more and 200 nm or less. The positive electrode material mixture layer including the first active material in the form of particles with a primary particle size of 10 nm or more and 500 nm or less can form a fluoride-ion secondary battery with an increased discharge capacity per unit mass of the positive electrode material mixture layer.

The second active material may be any suitable metal having a fluorination potential lower than that of the first active material, such as W, V, Bi, Sb, Ni, or Sn. The second active material may include a combination of two or more of such metals. In particular, the second active material is preferably Bi in view of the discharge capacity of the fluoride-ion secondary battery per unit mass of the positive electrode material mixture layer.

The fluorination potential of the second active material is typically, but not limited to, −0.2 V or more (vs. Pb/PbF₂) and 0.5 V or less (vs. Pb/PbF₂).

The second active material is preferably in the form of particles with a primary particle size of 10 nm or more and 500 nm or less, and more preferably 10 nm or more and 300 nm or less. The positive electrode material mixture layer including the second active material in the form of particles with a primary particle size of 10 nm or more and 500 nm or less can form a fluoride-ion secondary battery with an increased discharge capacity per unit mass of the positive electrode material mixture layer.

The first and second active materials preferably form a composite. Such a composite can form a fluoride-ion secondary battery with an increased discharge capacity per unit mass of the positive electrode material mixture layer.

The first and second active materials may be formed into a composite using a mechanical force. The first and second active materials may also be formed into a composite by an aerosol process. For example, the first and second active materials may be melted, and then sprayed under reduced pressure.

The positive electrode material mixture layer preferably further includes a third active material containing fluorine. Such a third active material has a fluoride-ion conductivity higher than that of a fluoride of the second active material. The positive electrode material mixture layer with such a feature can form a fluoride-ion secondary battery with an increased discharge capacity per unit mass of the positive electrode material mixture layer.

The third active material may be any metal fluoride having a fluoride-ion conductivity higher than that of a fluoride of the second active material. In particular, in view of the discharge capacity of the fluoride-ion secondary battery per unit mass of the positive electrode material mixture layer, the third active material is preferably a compound that is represented by the formula:

$${K}_{x} B {i}_{1 - x} {F}_{3 - 2 x} ,$$

where x is 0.02 or more and 0.12 or less,
and has a hexagonal structure.

The third active material is preferably in the form of particles with a primary particle size of 10 nm or more and 200 nm or less, more preferably 10 nm or more and 100 nm or less. The positive electrode material mixture layer including the third active material in the form of particles with a primary particle size of 10 nm or more and 200 nm or less can form a fluoride-ion secondary battery with an increased discharge capacity per unit mass of the positive electrode material mixture layer.

Next, it will be described what behavior the positive electrode including Cu, Bi, and K_{0.06}Bi_{0.94}F_{2.88} as the first, second, and third active materials, respectively, will exhibit in a fluoride-ion secondary battery during charging and discharging. In this regard, the fluorination potentials of Cu and Bi are 0.65 V (vs. Pb/PbF₂) and 0.31 V (vs. Pb/PbF₂), respectively.

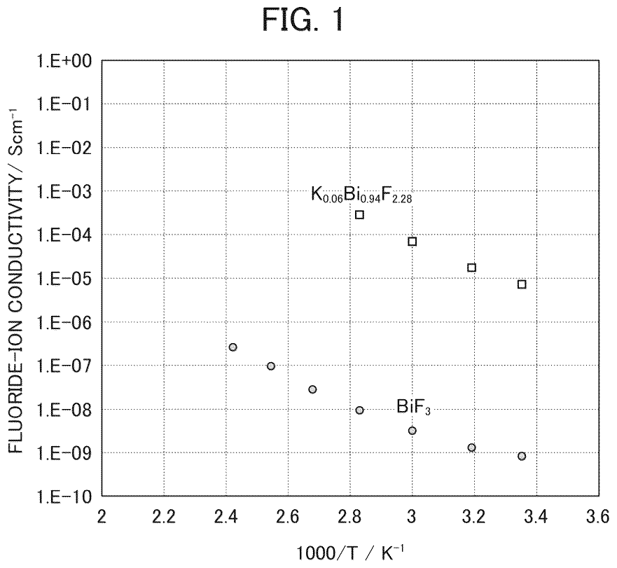

During the charging of the fluoride-ion secondary battery, Bi, which has a lower fluorination potential than Cu and forms a composite with Cu, is first fluorinated to form BiF₃. During the charging, the presence of K_{0.06}Bi_{0.94}F_{2.88} (see FIG. 1), which has a higher fluoride-ion conductivity than BiF₃, allows more effective utilization of Bi. Next, Cu, which has a higher fluorination potential than Bi and has formed a composite with Bi, is fluorinated to form CuF₂. During this process, the presence of BiF₃ and K_{0.06}Bi_{0.94}F_{2.88}, which has a higher fluoride-ion conductivity than BiF₃, allows for more effective utilization of Cu.

On the other hand, during the discharging of the fluoride-ion secondary battery, CuF₂ is first defluorinated to Cu. During this process, the presence of BiF₃, which forms a composite with Cu, and K_{0.06}Bi_{0.94}F_{2.88}, which has a higher fluoride-ion conductivity than BiF₃, allows for more effective utilization of CuF₂. Next, BiF₃ is defluorinated to Bi, and K_{0.06}Bi_{0.94}F_{2.88} is defluorinated. During this process, the presence of K_{0.06}Bi_{0.94}F_{2.88}, which has a higher fluoride-ion conductivity than BiF₃, allows for more effective utilization of BiF₃. Thus, the fluoride-ion secondary battery exhibits an increased discharge capacity per unit mass of the positive electrode material mixture layer.

The positive electrode material mixture layer preferably further includes a solid electrolyte containing fluorine. In this case, during the discharging of the fluoride-ion secondary battery, the presence of the solid electrolyte containing fluorine allows for effective utilization of the fluoride of the second active material and the third active material in the process of defluorinating the fluoride of the second active material and the third active material. This allows the fluoride-ion secondary battery to exhibit an increased discharge capacity per unit mass of the positive electrode material mixture layer.

The solid electrolyte may be any metal fluoride that has the ability to conduct fluoride ions and does not undergo defluorination during the discharging of the fluoride-ion secondary battery. Examples of such a metal fluoride include Ce_{0.975}Sr_{0.025}F_{2.975}, La_{0.93}Ba_{0.07}F_{2.93}, Ca_{0.5}Sr_{0.5}F₂, Sr_{0.7}Y_{0.3}F_{2.3}, Ba_{0.7}Sb_{0.3}F_{2.3}, La_{0.9}Sr_{0.1}F_{2.9}, and Ba_{0.5}Ca_{0.5}F₂. The solid electrolyte may include a combination of two or more of such metal fluorides.

If necessary, the positive electrode material mixture layer may further contain a conductive aid and any other additive. The conductive aid may be any suitable material having electron conductivity, such as acetylene black.

The positive electrode current collector may be any suitable material having electron conductivity, such as a gold foil.

### Fluoride-Ion Secondary Battery

An embodiment of the present invention is directed to a fluoride-ion secondary battery including the positive electrode according to an embodiment of the present invention. For example, the fluoride-ion secondary battery includes the positive electrode according to an embodiment of the present invention, a negative electrode, and a solid electrolyte layer provided between the positive and negative electrodes.

The negative electrode may include a negative electrode current collector and a negative electrode material mixture layer provided on the negative electrode current collector. The negative electrode material mixture layer includes a negative electrode active material and, if necessary, may further include a solid electrolyte, a conductive aid, and any other material.

The negative electrode current collector may be any suitable material having electron conductivity, such as an aluminum foil. The negative electrode active material may be any suitable material, such as PbSnF₄. The conductive aid may be any suitable material having electron conductivity, such as acetylene black.

The solid electrolyte layer may include any suitable solid electrolyte having fluoride-ion conductivity, such as Ce_{0.95}Sr_{0.05}F_{2.85}.

The fluoride-ion secondary battery according to an embodiment of the present invention may be produced by a process including: for example, stacking in order of the positive electrode current collector, the positive electrode material mixture, the solid electrolyte, the negative electrode material mixture, and the negative electrode current collector; and then forming them into an integrated structure.

The embodiments of the present invention described above are not intended to limit the present invention and may be modified as appropriate within a scope of the gist of the present invention.

### Examples

Hereinafter, the present invention will be described with reference to examples, which are not intended to limit the present invention.

Preparation of K_{0.06}Bi_{0.94}F_{2.88}

Potassium fluoride (manufactured by Kojundo Chemical Lab. Co., Ltd.) and bismuth fluoride (manufactured by Kojundo Chemical Lab. Co., Ltd.) were weighed, and then premixed using an agate mortar and an agate pestle for about 1 hour to form a raw material mixture powder.

The resulting raw material mixture powder was classified using a stainless steel mesh with an aperture of 500 μm. Subsequently, the fraction of the raw material mixture powder remaining on the mesh was subjected to mixing using an agate mortar and an agate pestle, and then subjected to the classification. This process was performed until no raw material mixture powder remained on the mesh.

In order to prevent the fluorides from absorbing moisture, the raw materials were weighed, premixed, and classified in a purge-type (DBO-type) glove box (manufactured by Miwa Mfg Co., Ltd.).

After the classification, the raw material mixture powder was enclosed in a gas-tight powder hopper, which was then removed from the glove box and connected to a radio-frequency induction thermal plasma nanoparticle synthesizer TP-40020NPS (manufactured by JEOL Ltd.). Next, while argon gas was supplied to the plasma torch, the raw material mixture powder was melted by the thermal plasma to form a molten raw material, which was sprayed into the chamber under reduced pressure. After being sprayed into the chamber, the molten raw material was cooled to form nanoparticles of K_{0.06}Bi_{0.94}F_{2.88}. Subsequently, the K_{0.06}Bi_{0.94}F_{2.88} nanoparticles were collected using an exhaust filter, and then transported into a glove box using valves to shut off flow upstream and downstream of the exhaust filter, so that the collection of the K_{0.06}Bi_{0.94}F_{2.88} nanoparticles was completed. The composition of the K_{0.06}Bi_{0.94}F_{2.88} nanoparticles was analyzed by inductively coupled plasma (ICP) emission spectrometry.

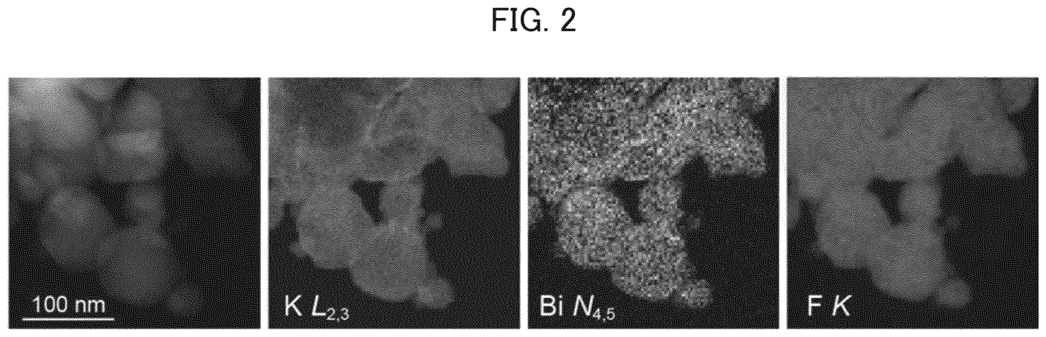

FIG. 2 shows the resulting TEM image and elemental mapping of the K_{0.06}Bi_{0.94}F_{2.88} nanoparticles. The TEM image and the elemental mapping were obtained by transmission electron microscopy-electron energy loss spectroscopy (TEM-EELS) analysis.

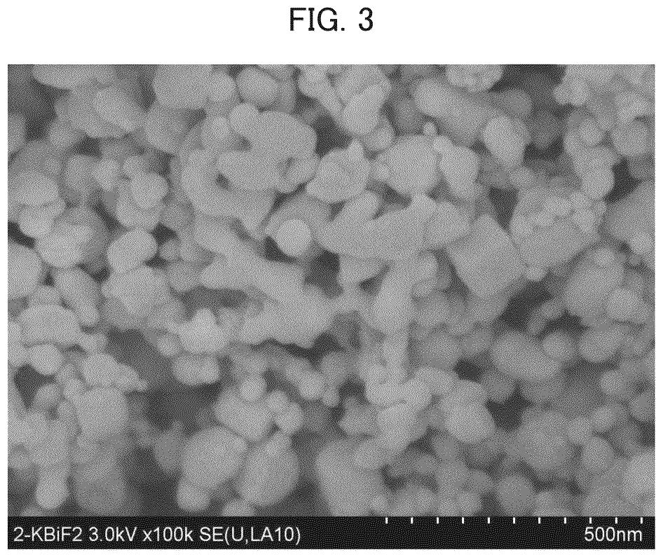

FIG. 3 shows an SEM image of the K_{0.06}Bi_{0.94}F_{2.88} nanoparticles.

From FIG. 3, it is apparent that the K_{0.06}Bi_{0.94}F_{2.88} nanoparticles have primary particle sizes of 10 nm or more and 100 nm or less.

Preparation of Ce_{0.92}Sr_{0.08}F_{2.92}

Cerium fluoride (manufactured by Kojundo Chemical Lab. Co., Ltd.) and strontium fluoride (manufactured by Kojundo Chemical Lab. Co., Ltd.) were weighed, and then premixed using an agate mortar and an agate pestle for about 1 hour to form a raw material mixture powder.

The resulting raw material mixture powder was classified using a stainless steel mesh with apertures of 500 μm. Subsequently, the fraction of the raw material mixture powder remaining on the mesh was subjected to mixing using an agate mortar and an agate pestle, and then subjected to the classification. This process was performed until no raw material mixture powder remained on the mesh.

In order to prevent the fluorides from absorbing moisture, the raw materials were weighed, premixed, and classified in a purge-type (DBO-type) glove box (manufactured by Miwa Mfg Co., Ltd.).

After the classification, the raw material mixture powder was enclosed in a gas-tight powder hopper, which was then removed from the glove box and connected to a radio-frequency induction thermal plasma nanoparticle synthesizer TP-40020NPS (manufactured by JEOL Ltd.). Next, while argon gas was supplied to the plasma torch, the raw material mixture powder was melted by the thermal plasma to form a molten raw material, which was sprayed into the chamber under reduced pressure. After being sprayed into the chamber, the molten raw material was cooled to form nanoparticles of Ce_{0.92}Sr_{0.08}F_{2.92}. Subsequently, the Ce_{0.92}Sr_{0.08}F_{2.92} nanoparticles were collected using an exhaust filter and then transported into a glove box using valves to shut off flow upstream and downstream of the exhaust filter, so that the collection of the Ce_{0.92}Sr_{0.08}F_{2.92} particles was completed. The composition of the Ce_{0.92}Sr_{0.08}F_{2.92} nanoparticles was analyzed by ICP emission spectrometry.

### Example 1

Copper (manufactured by Kojundo Chemical Lab. Co., Ltd.), bismuth (manufactured by Kojundo Chemical Lab. Co., Ltd.), the K_{0.06}Bi_{0.94}F_{2.88} nanoparticles, and acetylene black (manufactured by Denka Company Limited) were weighed in a mass ratio of 50.0:16.7:31.1:2.2, and then placed in a silicon nitride pot with a volume of 45 mL. Next, after silicon nitride balls with a diameter of 2 mm and cyclohexane were added to the pot, the raw materials were ground with the balls and cyclohexane. The grinding was performed using 40 cycles of rotating the pot at 200 rpm for 15 minutes and pausing the rotation for 5 minutes. The ground raw materials were then dried to give a positive electrode material mixture.

In order to prevent the fluoride from absorbing moisture and prevent copper from oxidizing, the raw materials were weighed and ground in a purge-type (DBO-type) glove box (manufactured by Miwa Mfg Co., Ltd.).

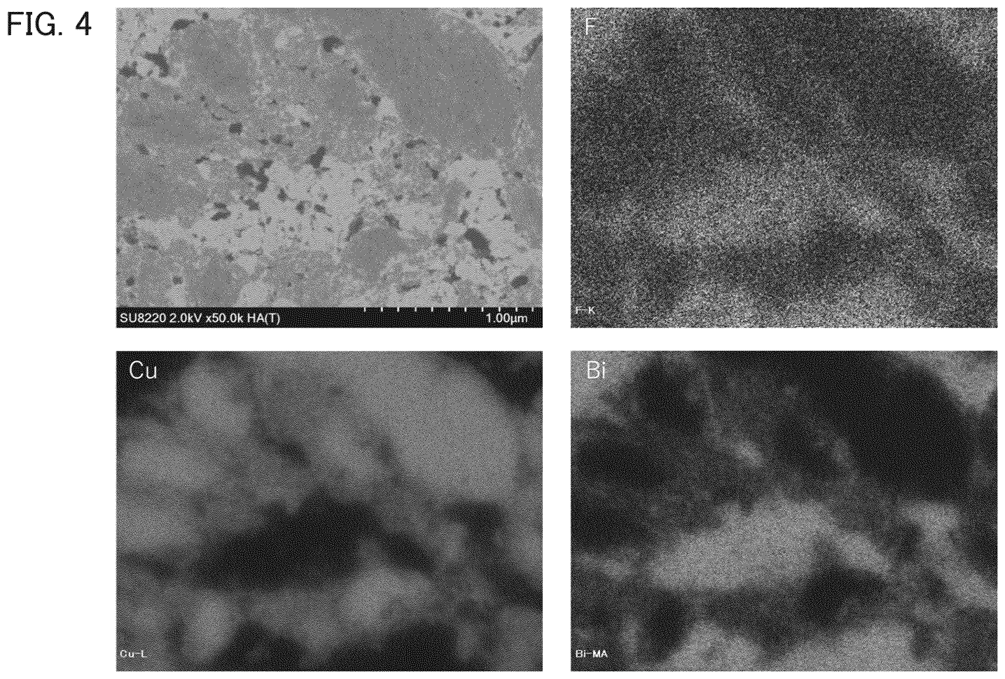

FIG. 4 shows an SEM image and elemental mapping of the positive electrode material mixture.

From FIG. 4, it is apparent that copper and bismuth form composite particles with primary particle sizes of 10 nm or more and 500 nm or less.

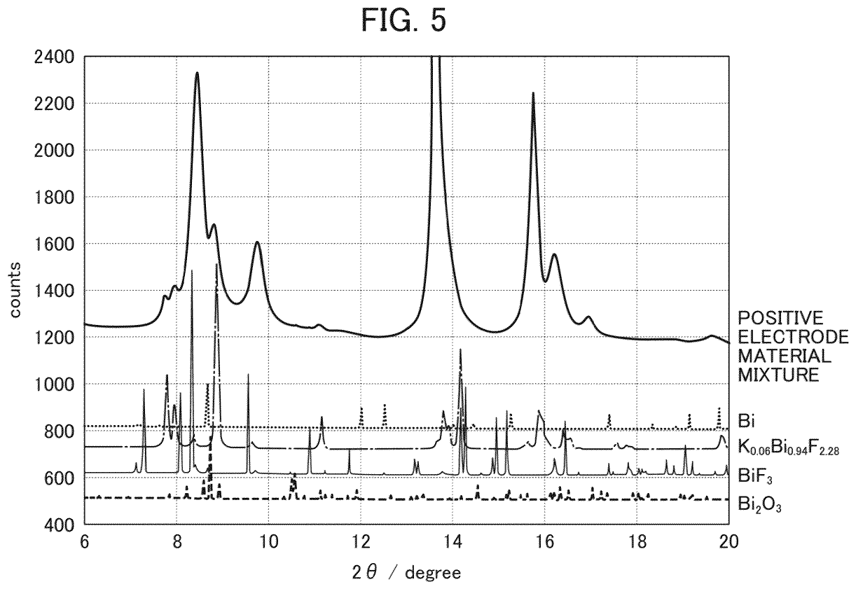

FIG. 5 shows an XRD spectrum of the positive electrode material mixture. FIG. 5 also shows XRD spectra of Bi, K_{0.06}Bi_{0.94}F_{2.88}, BiF₃, and Bi₂O₃. The XRD spectra were measured at an X-ray energy of 25 keV (λ=0.496 Å).

From FIG. 5, it is apparent that the positive electrode material mixture is free of BiFs and contains K_{0.06}Bi_{0.94}F_{2.88} with a hexagonal structure.

### Example 2

A positive electrode material mixture was obtained as in Example 1 except that copper (manufactured by Kojundo Chemical Lab. Co., Ltd.), bismuth (manufactured by Kojundo Chemical Lab. Co., Ltd.), the K_{0.06}Bi_{0.94}F_{2.88} particles, and acetylene black (manufactured by Denka Company Limited) were weighed in a mass ratio of 53.2:17.8:26.8:2.2.

### Example 3

A positive electrode material mixture was obtained as in Example 1 except that copper (manufactured by Kojundo Chemical Lab. Co., Ltd.), bismuth (manufactured by Kojundo Chemical Lab. Co., Ltd.), the K_{0.06}Bi_{0.94}F_{2.88} particles, the Ce_{0.92}Sr_{0.08}F_{2.92} particles, and acetylene black (manufactured by Denka Company Limited) were weighed in a mass ratio of 53.2:17.8:14.4:12.4:2.2.

### Example 4

Copper (manufactured by Kojundo Chemical Lab. Co., Ltd.), bismuth (manufactured by Kojundo Chemical Lab. Co., Ltd.), the K_{0.06}Bi_{0.94}F_{2.88} particles, and acetylene black (manufactured by Denka Company Limited) were weighed in a mass ratio of 37.3:29.3:31.2:2.2, and then premixed using an agate mortar and an agate pestle for about 1 hour to form a raw material mixture powder.

The resulting raw material mixture powder was classified using a stainless steel mesh with an aperture of 500 μm. Subsequently, the fraction of the raw material mixture powder remaining on the mesh was subjected to mixing using an agate mortar and an agate pestle, and then subjected to the classification. This process was performed until no raw material mixture powder remained on the mesh.

In order to prevent the fluoride from absorbing moisture and prevent copper from oxidizing, the raw materials were weighed, premixed, and classified in a purge-type (DBO-type) glove box (manufactured by Miwa Mfg Co., Ltd.).

After the classification, the raw material mixture powder was enclosed in a gas-tight powder hopper, which was then removed from the glove box and connected to a radio-frequency induction thermal plasma nanoparticle synthesizer TP-40020NPS (manufactured by JEOL Ltd.). Next, while argon gas was supplied to the plasma torch, the raw material mixture powder was melted by the thermal plasma to form a molten raw material, which was sprayed into the chamber under reduced pressure. After being sprayed into the chamber, the molten raw material was cooled to form a positive electrode material mixture including nanoparticles of a composite (Cu—Bi), K_{0.06}Bi_{0.94}F_{2.88}, and acetylene black. Subsequently, the positive electrode material mixture was collected using an exhaust filter, and then transported into a glove box using valves to shut off flow upstream and downstream of the exhaust filter, so that the collection of the positive electrode material mixture was completed.

### Example 5

A positive electrode material mixture was obtained as in Example 1 except that the Ce_{0.92}Sr_{0.08}F_{2.92} particles were used instead of the K_{0.06}Bi_{0.94}F_{2.88} particles.

### Comparative Example 1

A positive electrode material mixture was obtained as in Example 5 except that bismuth (manufactured by Kojundo Chemical Lab. Co., Ltd.) was used instead of copper (manufactured by Kojundo Chemical Lab. Co., Ltd.).

### Preparation of Fluoride-Ion Secondary Battery

Fluoride-ion secondary batteries were prepared using the positive electrode material mixtures of Examples 1 to 5 and Comparative Example 1, respectively.

PbSnF₄ (negative electrode active material) and acetylene black (conductive aid) (manufactured by Denka Company Limited) were mixed in a mass ratio of 70:5 to form a negative electrode material mixture.

Cells were prepared using an alumina tube with an inner diameter of 10 mm. Specifically, first, 150 mg of Ce_{0.95}Sr_{0.05}F_{2.85} (solid electrolyte) was pressed at a pressure of 740 MPa to form a solid electrolyte layer. Next, 10 mg of the positive electrode material mixture and a gold foil (positive electrode current collector) were stacked on one surface of the solid electrolyte layer, and 20 mg of the negative electrode material mixture and an aluminum foil (negative electrode current collector) were stacked on the other surface of the solid electrolyte layer. The resulting stack was uniaxially pressed at a pressure of 185 MPa to form a cell. The cell was then sealed in an air-tight glass vessel while applying a confining pressure of about 340 MPa.

### Charge-Discharge Capacity

After the pressure in the glass vessel was reduced by a vacuum pump, the cell was subjected to a constant current charge-discharge test at a temperature of 140° C. Specifically, the constant current charge-discharge test was performed using a potentio-galvanostat SI 1287/1255B (manufactured by Solartron), in which the cell was charged with a current of 120 μA until the voltage reached 1.5 V (vs. Pb/PbF₂), and then charged again with a current of 40 μA until the voltage reached 1.5 V. Next, the cell was discharged at a current of 120 μA until the voltage reached-0.5 V, and then discharged again at a current of 40 μA until the voltage reached-0.5 V. During the constant current charge-discharge test, the cell was held in a compact environmental test chamber SU261 (manufactured by Espec Corporation) for controlling the temperature of the cell during the charging and discharging.

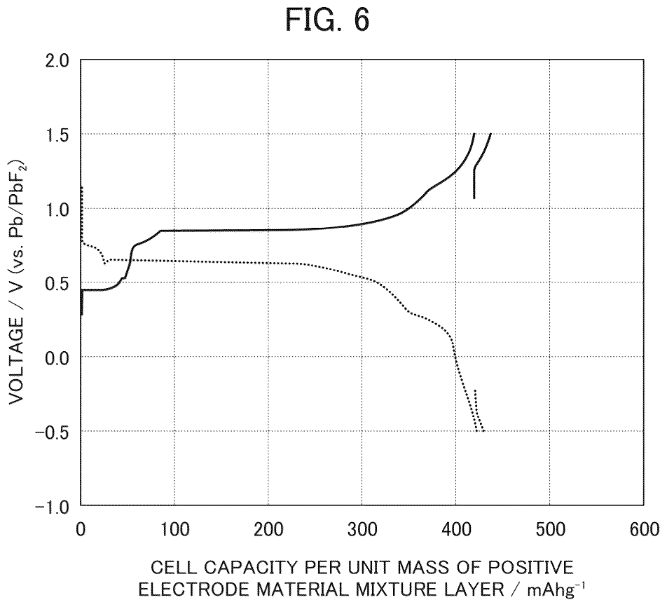

FIG. 6 shows the charge-discharge curve of the cell of Example 3.

Table 1 shows the results of the evaluation of the discharge capacity of each of the cells per unit mass of the positive electrode material mixture layer. In Table 1, AB represents acetylene black.

TABLE 1

| | | | | | | | Discharge capacity |
|---|---|---|---|---|---|---|---|
| | | | | | | | of cell per unit |
| | Composition (mass %) of positive | | | | | | mass of positive |
| | electrode material mixture layer | | | | | Molar ratio | electrode material |
| | Cu | Bi | K [symbol] Bi [symbol] F [symbol] | Ce [symbol] S [symbol] F [symbol] | AB | of Cu to Bi | mixture layer/mAhg [symbol] |
| Example 1 | 50.0 | 16.7 | 31.1 | — | 2.2 | 9.8 | 350 |
| Example 2 | 53.2 | 17.8 | 26.8 | — | 2.2 | 9.9 | 410 |
| Example 3 | 53.2 | 17.8 | 14.4 | 12.4 | 2.2 | 9.9 | 430 |
| Example 4 | 37.3 | 29.3 | 31.2 | — | 2.2 | 4.2 | 400 |
| Example 5 | 50.0 | 16.7 | — | 31.1 | 2.2 | 9.8 | 300 |
| Comparative | 0 | 66.7 | — | 31.1 | 2.2 | 0 | 250 |
| Example 1 | | | | | | | |

[symbol]

indicates data missing or illegible when filed

From Table 1, it is apparent that each of the cells of Examples 1 to 5 has a relatively high discharge capacity per unit mass of the positive electrode material mixture layer. In contrast, the cell of Comparative Example 1, in which the positive electrode material mixture layer contains no first active material, has a relatively low discharge capacity per unit mass of the positive electrode material mixture layer.

What is claimed is:

1. A positive electrode comprising: a positive electrode current collector; and a positive electrode material mixture layer provided on the positive electrode current collector, the positive electrode material mixture layer comprising:
a first active material containing no fluorine; and a second active material containing no fluorine,
the positive electrode material mixture layer having a molar ratio of the first active material relative to the second active material of 4 or more and 35 or less, and
the first active material having a fluorination potential higher than that of the second active material.

2. The positive electrode according to claim 1, wherein the first active material and the second active material form a composite.

3. The positive electrode according to claim 1,
wherein the positive electrode material mixture layer further comprises a third active material containing fluorine, and
wherein the third active material has a fluoride-ion conductivity higher than that of a fluoride of the second active material.

4. The positive electrode according to claim 3,
wherein the first active material is copper,
wherein the second active material is bismuth, and
wherein the third active material is a compound that is represented by the formula:
$${K}_{x} {Bi}_{1 - x} {F}_{3 - 2 x} ,$$
wherein x is 0.02 or more and 0.12 or less,
and has a hexagonal structure.

5. The positive electrode according to claim 3,
wherein the first active material is in the form of particles with a primary particle size of 10 nm or more and 500 nm or less,
wherein the second active material is in the form of particles with a primary particle size of 10 nm or more and 500 nm or less, and
wherein the third active material is in the form of particles with a primary particle size of 10 nm or more and 200 nm or less.

6. The positive electrode according to claim 1, wherein the positive electrode material mixture layer further comprises a solid electrolyte containing fluorine.

7. The positive electrode according to claim 6, wherein the solid electrolyte is a metal fluoride containing cerium and strontium.

8. A fluoride-ion secondary battery comprising the positive electrode according to claim 1.
